(19) United States
(12) Patent Application Publication
(10) Pub. No.: US 2025/0386263 A1
(43) Pub. Date: Dec. 18, 2025

(54) PROVIDING SYSTEM INFORMATION

(71) Applicant: Nokia Technologies Oy, Espoo (FI)

(72) Inventors: Naizheng ZHENG, Beijing (CN); Chunli WU, Beijing (CN); Tao TAO, Shanghai (CN); Daniela LASELVA, Aalborg (DK); Jorma Johannes KAIKKONEN, Oulu (FI)

(21) Appl. No.: 18/876,454

(22) PCT Filed: Jul. 11, 2022
(86) PCT No.: PCT/CN2022/105012

§ 371 Date: Dec. 18, 2024

(51) Int. Cl. H04W 36/08; H04W 56/00; H04W 76/20

(52) U.S. Cl. CPC H04W 36/08; H04W 56/0015; H04W 76/20

(57) ABSTRACT

Apparatuses and methods are provided for enabling a communication device in a cell of a network access the cell based on system information received from the network. The system information is stored in at least one memory of the communication device for use in access to a cell when network provided system information is unavailable in the cell. When it is determined that network provided system information is unavailable in the cell, a validity timer is started for the system information stored in the at least one memory. Operations for access to the cell are performed based on the stored system information until expiry of the validity timer. After expiry of the validity timer system information for the cell is requested from the network and/or reselection to another cell is initiated.

### FIELD

The present disclosure relates to methods, apparatuses and computer program products for providing devices with system information for access to a communication system.

### BACKGROUND

Data can be communicated in a communication system between communication devices such as user or other terminal devices, and network entities such as base stations/access points and/or other network nodes. An access network typically provides devices with access to the communication system. An access network is provided with an appropriate signal receiving and transmitting apparatus for enabling communications and enabling devices to access the communication system. In a mobile or wireless communication system at least a part of data communication between at least two devices occurs over a wireless or radio link. Examples of wireless systems comprise public land mobile networks (PLMN), satellite-based communication systems and different wireless local networks, for example wireless local area networks (WLAN).

A communication system can be accessed by means of an appropriate wireless communication device which is often referred to as user equipment (UE). A communication device of a user may receive signalling by a node at a radio access network, for example a base station, and transmit and/or receive communications accordingly. The communications may comprise, for example, communications such as voice, video, electronic mail (email), text message, multimedia and/or content data and so on. Non-limiting examples of services comprise two-way or multi-way calls, data communication, multimedia services and access to a data network system, such as the Internet.

Control information can be multicast/broadcast to wireless devices. Broadcast refers to the ability to transmit information to multiple users in a broadcast area. The broadcast can comprise signalling control information such as system information (SI) to devices in the service area. The devices can then use the broadcast system information for access to the communication system.

The communication system and associated devices typically operate in accordance with a given standard or specification which sets out what the various entities associated with the system are permitted to do and how that should be achieved. Communication protocols and/or parameters which shall be used for access to the system and the communications are also typically defined. One example of a communications system is UTRAN (3G radio). Other examples of communication systems are the long-term evolution (LTE) of the Universal Mobile Telecommunications System (UMTS) radio-access technology and so-called fifth generation (5G) or New Radio (NR) networks. 5G is being standardized by the 3rd Generation Partnership Project (3GPP).

Reducing the energy consumption of communication networks and devices would be desirable. This may be particularly desirable in access operations, for example accessing a radio access network (RAN). Access operations and maintaining readiness for access uses resources both at the network and at the devices and can cause a considerable part of the total energy consumption.

### SUMMARY

In accordance with an aspect there is provided an apparatus comprising at least one processor and at least one memory including a computer program code, the at least one memory and computer program code configured to, with the at least one processor, cause the apparatus at least to store system information in the at least one memory for use by a communication device in access to a cell when network provided system information is unavailable in the cell, determine that network provided system information is unavailable in the cell, start a validity timer for the system information stored in the at least one memory, perform operations for access to the cell based on the stored system information until expiry of the validity timer, and after expiry of the validity timer at least one of request for system information for the cell from the network or initiate reselection to another cell.

According to an aspect there is provided an apparatus comprising at least one processor and at least one memory including a computer program code, the at least one memory and computer program code configured to, with the at least one processor, cause the apparatus at least to send system information to a communication device in a cell for storage in a memory of the communication device for use in access to the cell when network provided system information is unavailable in the cell, indicate to the communication device that the cell is operated in a mode of operation where system information is not available in the cell, indicate a validity timer for the system information stored in the memory, and allow access by the communication device to the cell based on the stored system information until expiry of the validity timer.

The communication device can be enabled, after reselection to another cell, to perform reselection back to the cell before expiry of the timer.

The communication device may be configured to check from the network if relevant system information has changed after the reselection back to the cell.

The communication device may be configured to use, until expiry of the validity timer and in response to receiving an indication that system information is not transmitted in the cell, the stored system information instead of considering the cell as barred.

The communication device may be configured to perform an on-demand system information block (SIB) procedure after the reselection back to camp in the cell when no system information can be acquired by the device in the cell.

The communication device may be configured to receive from the network configuration information for the validity timer.

The system information can comprise information of at least one of paging configurations, random access channel configurations, cell reselection configurations, small data transmission configurations, and/or unified access control configurations.

The system information and/or timer configuration information may be comprised in a system information block (SIB), master information block (MIB), synchronization signal block (SSB) and/or a radio resource control (RRC) message. In accordance with a specific aspect the system information is comprised in a system information block 1 (SIB1).

The communication device may be configured to, in response to expiry of the timer, acquire relevant system information block (SIB) or synchronization information block (SSB) from the network, and in response to not detecting the requested SIB or SSB consider the cell as barred and reselect another cell.

In accordance with an aspect there is provided a method in a communication device comprising storing system information in at least one memory for use in access to a cell when network provided system information is unavailable in the cell, determining that network provided system information is unavailable in the cell, starting a validity timer for the system information stored in the at least one memory, performing operations for access to the cell based on the stored system information until expiry of the validity timer, and after expiry of the validity timer at least one of requesting for system information for the cell from the network or initiating reselection to another cell.

In accordance with an aspect there is provided a method for a network device comprising sending system information to a communication device in a cell for storage in a memory of the communication device for use in access to the cell when network provided system information is unavailable in the cell, indicating to the device that the cell is operated in a mode of operation where system information is not available in the cell, indicating a validity timer for the system information stored in the memory, and allowing access by the device to the cell based on the stored system information until expiry of the validity timer.

The method may comprise the communication device performing, after reselection to another cell, reselection back to the cell before expiry of the timer.

The method may comprise the communication device checking from the network if relevant system information has changed after the reselection back to the cell.

The communication device may, in response to receiving an indication that system information is not transmitted in the cell, use the stored system information instead of considering the cell as barred.

The method may comprise the communication device performing an on-demand system information block (SIB) procedure after reselection back to camp in the cell when no system information can be acquired by the communication device in the cell.

The method may comprise the network sending and/or the communication device receiving from the network configuration information for the validity timer.

The method may comprise communicating the system information comprising information of at least one of paging configurations, random access channel configurations, cell reselection configurations, small data transmission configurations, and/or unified access control configurations.

The method may comprise sending and/or receiving system information and/or timer configuration information in a system information block (SIB), master information block (MIB), synchronization signal block (SSB) and/or a radio resource control (RRC) message. The method may comprise sending and/or receiving system information in a system information block 1 (SIB1).

The method may comprise the communication device, in response to expiry of the timer, acquiring relevant system information block (SIB) or synchronization information block (SSB) from the network, and in response to not detecting the requested SIB or SSB consider the cell as barred and reselecting another cell.

In accordance with a specific aspect the apparatuses are configured to transfer between operation where system information is broadcast in the cell and operation where system information is not broadcast in the cell

According to an aspect indication that system information block (SIB) information enabling access to the cell is not broadcast in the cell is provided in a master information block (MIB).

An indication that system information enabling access to the cell is not broadcast in the cell may also be provided in a radio resource control (RRC) release message.

The device can be configured to acquire system information from the network in response to one of a notification by the network, a cell reselection, a handover, and an expiry of a timer.

Apparatus in network can be configured to, in response to determination that sending of system information in the cell is unnecessary, signal an indication that system information will not be transmitted in the cell and/or refrain from broadcasting the system information in the cell.

A device in the cell may be configured to, in response to receiving indication that system information is not provided for the cell, use the stored system information for access to the cell instead of considering the cell as barred.

A device in the cell may be configured to perform an on-demand system information block (SIB) procedure when a system information block enabling access to the cell is not broadcast in the cell.

Means for implementing the herein disclosed operations and functions can also be provided. The means can comprise appropriately configured hardware and software.

A computer software product embodying at least a part of the herein described functions may also be provided. In accordance with an aspect a computer program comprises instructions for performing at least one of the methods described herein.

### BRIEF DESCRIPTION OF DRAWINGS

Some aspects will now be described in further detail, by way of example only, with reference to the following examples and accompanying drawings, in which:

FIG. 1 illustrates an example of a communication system where the invention can be practiced;

FIG. 2 shows a data processing apparatus; and

FIGS. 3 to 12 are flowcharts according to certain illustrative examples.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communication systems can provide mobile communications to devices connected therein. Typically, an access point such as a base station is provided for enabling the communications for devices connected to the access point. In the following, different scenarios will be described using, as an example of an access architecture, a 3GPP 5G radio architecture. However, embodiments are not necessarily limited to such an architecture. Some examples of options for suitable systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBeeR, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof. The principles can also be applied to any next generation access systems.

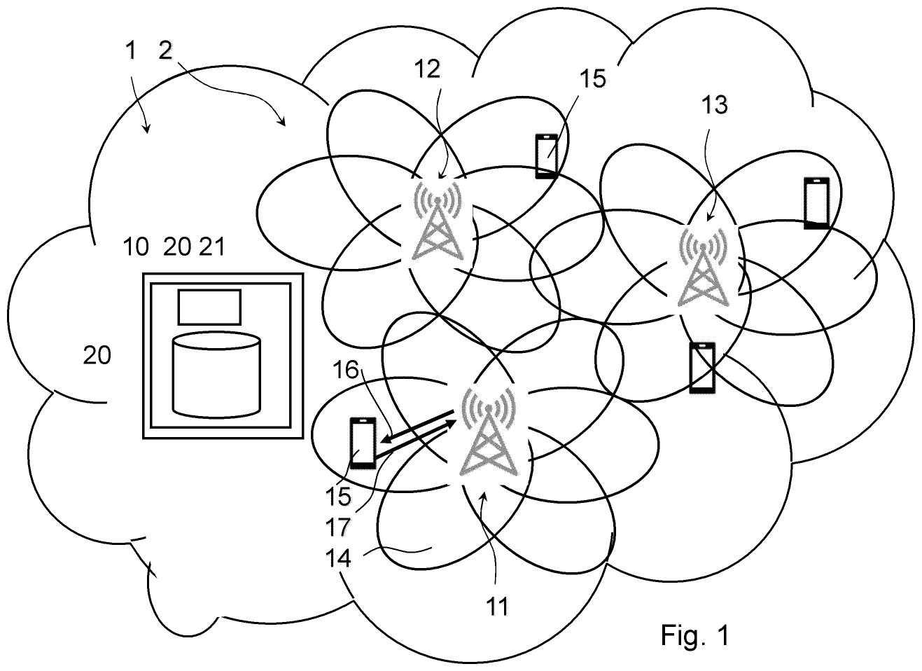

FIG. 1 shows a schematic example of a communication system 1 comprising a radio access system or radio access network (RAN) 2. A radio access network can comprise one or a plurality of access points, or base stations 11, 12 and 13. A base station may provide one or more cells 14 serving wireless communication devices or user equipment (UE) 15. These terms are used interchangeably throughout this specification. An access point can comprise any node that can transmit/receive radio signals (e.g., a 3GPP 5G base station such as gNB, eNB, a user device providing a hotspot, a Tx/Rx Point (TRP) and so forth). A large number of radio access networks can be provided in a communication system. A radio access network can comprise a number of base stations.

Communication devices 15 can be located in the service area of the radio access network 2. For simplicity, only a few devices are shown. Devices 15 in cells 14 can listen to and camp in the cells provided by access points 11-13. Camping on a cell refers to a state in which the device stays on the cell and is ready to initiate a potential dedicated service or to receive an ongoing broadcast service.

FIG. 1 shows also a control function entity 10. This can comprise an appropriate controller at the network configured to control one or more of the of the access nodes 11, 12 and 13. The control function entity 10 can also be configured to control delivery of system information to the devices 15 in the cells as explained below. Non-limiting examples of possible network control functions include a medium access control (MAC) entity and/or a radio resource control (RRC) entity.

It is noted that the wider communication system is only shown as cloud 1 and can comprise a number of elements which are not shown for clarity. For example, various operations and functions in accordance with a 5G based system may be comprised in a terminal or user equipment (UE), a 5G radio access network (5GRAN) or next generation radio access network (NG-RAN), a 5G core network (5GC), one or more application functions (AF) and one or more data networks (DN). The 5G-RAN may comprise one or more gNodeB (gNB) or one or more gNodeB distributed unit functions connected to one or more gNodeB centralized unit functions. The 5GC may also comprise entities such as Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); various Session Management Functions (SMF) and so on.

The communication devices 15 may be any suitable devices adapted for wireless communications. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices, a Cellular Internet of things (CIoT) device or any combinations of these or the like. The device may be provided as part of another device. The device may receive signals over an air or radio interface via appropriate apparatus for receiving and may transmit signals via appropriate apparatus for transmitting radio signals. The communications can occur via multiple paths. The communications device can be provided with the capability of carrier aggregation (CA) and wireless communications via component carriers (CC). To enable multiple input multiple output (MIMO) type communications devices may be provided with multiantenna elements.

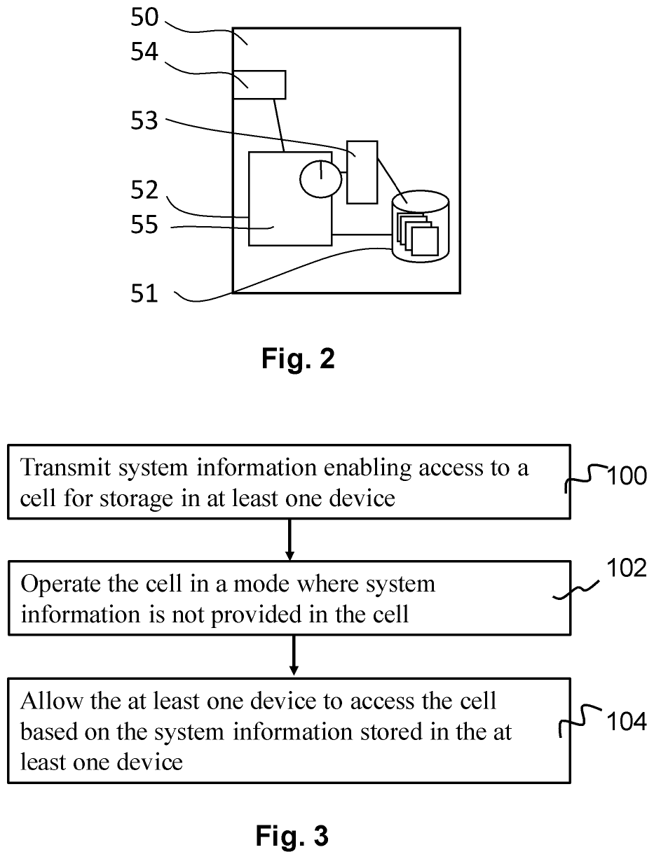

Devices such as base stations, terminal devices and network functions are provided with data processing apparatus comprising at least one processor and at least one memory. FIG. 1 shows an example of a data processing apparatus 20 for the network controller entity 10. FIG. 2 shows an example of a data processing apparatus 50 for a communication device 15 of FIG. 1.

A data processing apparatus typically comprises processor(s) 22, 52, 53 and memory or memories 21 and 51. FIG. 2 also shows connections between the elements of the apparatus. An interface 54 for connecting the data processing apparatus to other components of the device is also shown. The at least one memory may comprise at least one ROM and/or at least one RAM. The communications device may comprise other possible components for use in software and hardware aided execution of tasks it is designed to perform, including implementing the herein described features in relation to handling system information and processing access relates tasks based on the system information. The at least one processor can be coupled to the at least one memory. The at least one processor may be configured to execute an appropriate software code to implement one or more of the following aspects. The software code may be stored in the at least one memory.

The following describes certain aspects, configurations and signaling of system information (SI). Signaling of system information (SI) can be provided via broadcast where control information is transmitted simultaneously from a single source to multiple destinations/devices is an area. Broadcast refers to the ability to transmit information to all users in an area that is a collection of one or more network access nodes, e.g., base stations, and/or cells capable of delivering the same information.

In FIG. 1 the signalling of system information from the access node 11 to one of the devices 15 is illustrated by arrow 16 and possible subsequent communications by the UE is illustrated by arrow 17. The base station 11 of the access network can broadcast the system information (SI) in elements such as Synchronization Signal Blocks/System Information Blocks (SSB/SIB) to the UE 15 in the cell.

The broadcasting can be frequent and cause considerable use of resources and power consumption. A reason for this is that the network needs to wake up periodically to send certain SIBs to ensure that any new UE entering the cell can camp on the cell. The SIBs can comprise SIB1 and any of SIB2 to SIB5, as necessary. SIB1 is a cell-specific information element which is only valid for the serving cell, and carries critical information required for the UE to be able to access the cell. SIB1 contains information relevant when evaluating if a UE is allowed to access a cell and can also include information related to the availability and scheduling of other system information, such as other SIBs, for example mapping of SIBs to a system information message, periodicity, SI-window size and so forth. SIB1 also contains radio resource configuration information that is common for all UEs and barring information applied to the unified access control. SIB2 to SIB5 element in turn can contain further information, for example cell reselection information.

System information is needed as it provides the UE with parameters necessary for access to the network and detection of paging messages. Random Access Channel (RACH) based on-demand System Information is supported for the new radio (NR), however the SIB1 messaging is not included in the RACH since it is the broadcast SIB1 information that provides the RACH configurations needed for the access to the cell.

There are occasions where frequent broadcasting of system information may not be necessary and may rather result inefficient use of resources. For example, there may be no new UEs nor SIB updates for large parts of the time in certain areas and/or in certain time periods and/or applications. Examples of this are nighttime, weekends and/or public holidays in an area populated with offices, schools and other like locations.

Occasions and periods where frequent sending of SIBs is not necessary can be identified and utilized in reducing power consumption by refraining from sending the SIBs. Such mode of operation is called hereinafter SIB-less mode operation. The SIB-less mode can be provided in both time and frequency domain techniques.

According to a possible mode of operation other SSBs are transmitted but operation is SIB1-less, i.e., SIB1 is not transmitted in the cell. According to a yet further possible mode of operation neither SSB nor SIB1 are transmitted in a cell. This mode can be used for further improved power savings.

An issue in SIB-less operation is how the UE can be provided with necessary paging/RACH configurations. Legacy UEs are prevented from camping on the cell if the cell is operated in SIB-less mode. The legacy UEs in here refer to devices not capable or configured for SIB-less mode operation. In the context of SIB-less operation and 3GPP specifications legacy UEs refer in the examples below to UEs configured according to 3GPP Release 17 and earlier. Legacy UEs can acquire the necessary SIBs from the broadcast. Legacy UEs can also re-acquire the SIBs in response to a SI modification notification. The legacy UEs may be provided with an indication that they are barred from the cell. This can be provided, e.g., by cellbarred indication in a MIB. Later UEs, i.e., SIB-less capable UEs according to, e.g., 3GPP Release 18 and later would also receive this indication. The SIB-less capable UEs are made aware that the network operates in the SIB-less mode, and the SIB-less capable UEs can consider the cellbarred indication redundant and stay in the SIB-less cell.

A cellbarred indication in a MIB can be jointly used with other fields in a MIB to indicate to the UE that the network (NW) is in the SIB-less mode. For example, a MIB message cellbarred+ssb-SubcarrierOffset or cellbarred+pdcch-ConfigSIB1 can be jointly used to indicate that the NW is in the SIB-less mode. A Release 18 capable UE aware of the stored system information can stay in the cell and use the stored system information after the NW has indicated the SIB-less mode of operation. A Release 18 non-capable UE without knowledge of the stored system information can perform a cell re-selection/HO to other cells in basically similar manner as legacy UEs.

A mechanism for transferring between the different modes of SIB operation in a cell from a legacy SIB mode to the SIB-less mode can be provided. A switching mechanism at the NW enables a flexible operation. The operation can be dynamic and responsive to changed conditions in the cell. Terms legacy mode, normal mode and the with-SIB mode of operation in this specification refer to the current SIB operation where SIBs are needed from the network for access thereto. Such mode of operation is referred to below as the SIB mode of operation. The mode of operation where frequent signaling of SIBs is not needed and the network pauses sending of system information, and more specifically SIBs is referred to as SIB-less mode of operation.

FIG. 3 is a flowchart of an example of operation for providing at least one device with system information for accessing a network. At 100 the network transmits system information enabling the at least one device to access a cell for storage in a memory of the at least one device. The transmission may comprise broadcast of system information in the cell. The system information may also be transmitted in a dedicated control information message. The cell is operated at 102 in a mode where the network does not provide system information for the cell. Thus the at least one device in the cell cannot receive any system information it would need for access. The at least one device is allowed at 104 to access the cell based on the system information stored in the at least one device.

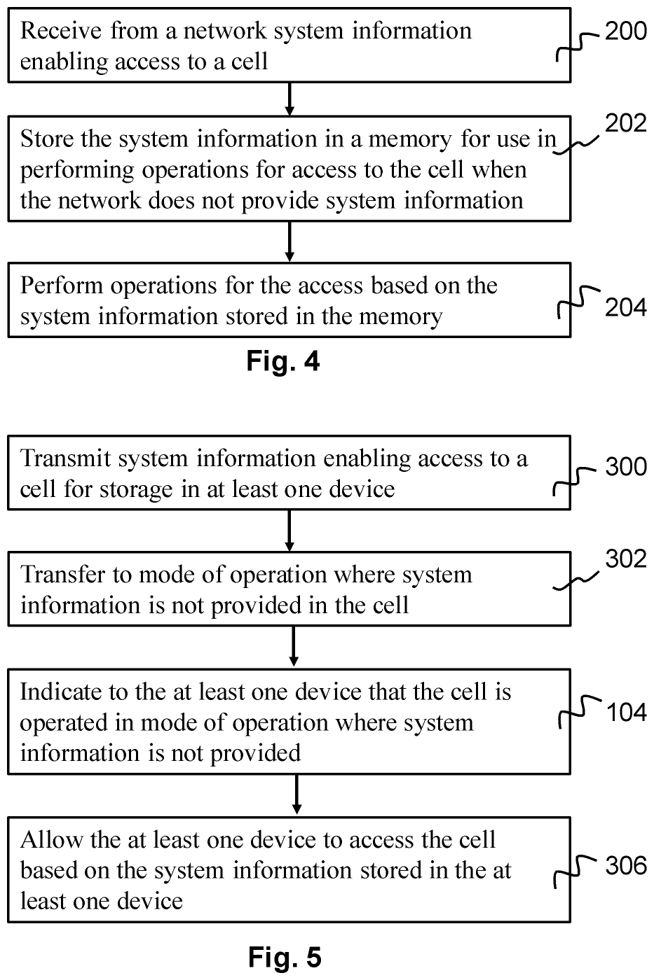

FIG. 4 shows an example of operation at a device for accessing a network. The device receives at 200 from the network system information enabling access to a cell. The system information is stored at 202 in a memory of the device for use by the device for performing operations for access to the cell when the network does not provide system information. The device in the cell can then perform at 204 necessary operations for the access based on the system information stored in the memory.

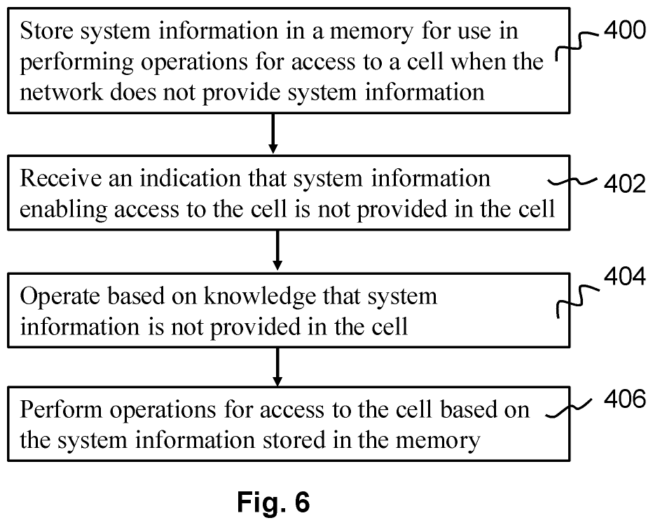

FIGS. 5 and 6 show examples of methods at the network and at a device, respectively, when the network transfers between modes of operation where system information is provided and system information is not provided by the network.

In FIG. 5 the network transmits at 300 system information enabling at least one device to access a cell for storage in a memory of the at least one device. A decision is made to switch from a first mode of operation where system information is transmitted in the cell to a second mode of operation where system information is not transmitted in the cell. The mode of operation is then changed accordingly at 302. The network transmits at 304 an indication of the change to the at least one device to inform the at least one device that the cell is operated in the second mode of operation. The at least one device is then allowed at 306 to access the cell based on the system information stored in the memory of the at least one device.

FIG. 6 shows an example of operation at a device when network transfers its mode to operation where no system information is transmitted in the cell. In the method the device stores at 400 system information enabling access to a cell in at least one memory for use in performing operations for access to the cell when system information is not provided in the cell. The device can receive this information, for example, during normal operation of the cell and/or in a RRC message, such as a RRC release message.

The device then receives at 402 an indication that system information enabling access to the cell is not provided in the cell. The device can then operate at 404 based on knowledge of the stored information and the indication of a transfer from the first mode of operation of the network where system information is provided in the cell to the second mode of operation where system information is not provided in the cell. Operations for access to the cell can then be performed at 406 based on the system information stored in the at least one memory.

The following describes more detailed examples of enabling operation without frequent system information messages using the context of SIB-less operation as the example. SIB-less operation can be enabled by configuring UEs to acquire from a given cell and store in a memory thereof necessary information which is required for idle/inactive mode operation in the given cell. This information may comprise information such as paging/RACH configurations and/or cell reselection and handover configurations.

According to a possibility the system information mode in a cell can be switched from the SIB mode to the SIB-less mode and vice-versa through an indication transmitted in a Master Information Block (MIB). Upon reception of the indication of the switch to the SIB-less mode, a UE can use the stored system information from a memory thereof. The UE can assume that there will be no further SIB update during the SIB-less mode.

After a switch of the network from the SIB-less mode back to the SIB mode or if a SIB update is needed during SIB-less mode, the NW can update the SIB mode indication in a further MIB. Reception of the further MIB can trigger the UE to re-acquire one or more SIBs. According to a possibility, the UE may re-acquire one or more SIBs if a SI modification notification is received.

The network may decide to operate in a mode of operation where no system information is transmitted based on various grounds. For example, the network may decide to dynamically apply SIB-less operation based on traffic load in a cell. For instance, in response to determining a very low traffic load the network may decide to switch-off part of its transmission and reception hardware with periods of time for power saving purposes. The network may decide to switch-off transmission of only SIB information. According to a possibility the network may decide to switch-off transmission of SSB and SIB1 information. The actual triggers for the switching can be network implementation specific. Non-limiting further examples include date and/or time of the day, detection that no new UEs have entered a cell for a pre-defined period, and so forth.

Decisions regarding use of mode of operation where no system information is transmitted can be made by any appropriate controller in the network. For example, a medium access control (MAC) entity and/or a RRC entity may make decisions to move in and out of SIB-less operation. According to a specific example a RRC entity may make the decision based on input from a MAC entity based on traffic load in a cell.

According to a specific example SIB1-less mode operation is provided where the network refrains for a period from sending of the SIB1 information for the cell. The UEs can then use the stored SIB1 information for the access in the cell. The UEs can request from the network other relevant SIBs via an on-demand mechanism.

A validity timer may be set for the stored system information. Until expiry of the validity timer the stored system information for a mode of operation where relevant system information is not transmitted can be assumed as valid. In the data processing apparatus 50 of FIG. 2 the validity timer function is denoted by reference 55. A corresponding validity timer for system information stored in the device(s) in a cell can also operate at the network side to maintain synchronization between the network and the device(s) in the cell. The network can configure the validity timer at the device(s). The configuration information may be provided, for example, through MIB or RRC signaling. The validity timer configuration information may be provided in the same message as the indication of the switch to operation where no system information is transmitted or separately.

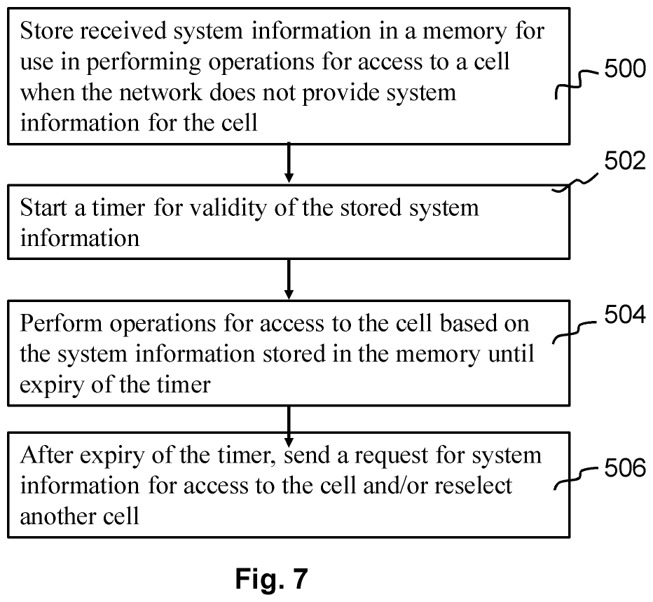

Example of operation of the timer at an accessing device is shown in FIG. 7. The device stores at 500 system information in at least one memory for use in access to a cell when network operates in a mode where system information is not available in the cell. The device starts at 502 a timer for validity of the system information stored in the at least one memory. Operations for access to the cell are performed at 504 based on the stored system information stored until expiry of the timer. After expiry of the timer, the device can send at 506 a request for system information for the cell. The device may alternatively, or additionally if, for example, no system information is received, perform cell reselection.

A function of the timer for the accessing device is to verify how long the stored system information can be considered as valid. When the system information becomes invalid, the device can check if the system information is available or reselect to another cell. In response to expiry of the timer the device can, for example, try to acquire a SIB1 or all relevant SIBs and/or SSBs, send a request for a relevant system information block or a relevant synchronization information block to the network. The device can consider the cell as barred and move to other cells if no further information is obtained from the network. Other operations to address the lack of valid system information may be taken.

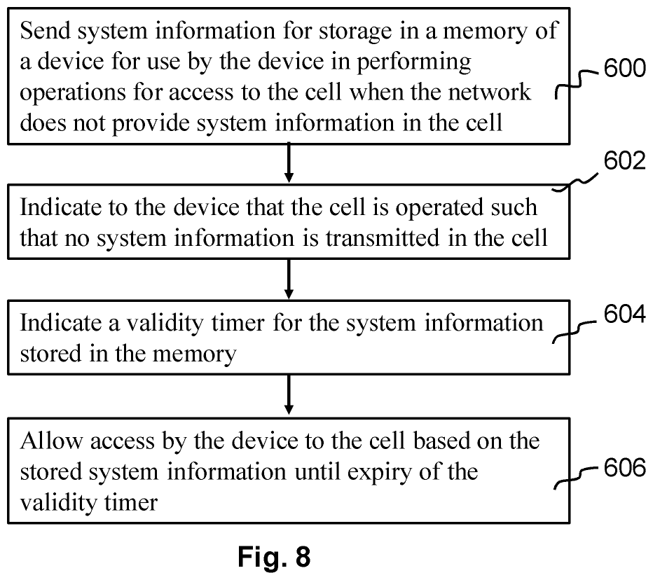

In addition, the network can control whether the UE should store the information for the cell upon cell reselection to a different cell. For example, the network can predict the longest time duration with no system information (SI) modification (or at least with no SIB1 modification) and set the validity timer accordingly. In such case, the stored information can be valid within the validity timer after the UE performs cell reselection away and then back to the given cell. According to one example, if a UE returns to camp to the cell when the UE is still operating in the SIB-less mode, the UE can perform an on-demand SIB procedure to check from the network whether any relevant SIB was modified. FIG. 8 shows an example for validity timer operation at the network side. The network can send at 600 system information to a device in a cell for storage in a memory of the device. The device can then use the stored information in access to the cell when network provided system information is unavailable in the cell, as explained above. The network indicates at 602 to the device that the cell is operated in a mode of operation where system information is not transmitted in the cell. The network also indicates at 604, at a same or different message than send at 602, a validity timer for the system information stored in the memory. The indication can comprise necessary configuration information for the timer. The network then allows at 606 the device to access to the cell based on the stored system information until expiry of the validity timer.

The validity timer can be valid even after the UE reselects to another cell and then moves back to the cell where the validity timer was started. The UE does not necessarily need to reacquire the SIBs since they might not even be there but can use the stored information. The UEs are aware how long time the stored SIB information is valid and can rely on the stored information when reselecting back to the original SIB-less cell. For example, information/indication provided in a RRC release message enables the UEs to camp on the cell without SIBs, and the UEs do not consider the cell as barred when they do not detect SIBs in the cell, as long as the timer is running. If the timer has expired when the UE re-enters the SIB-less cell, use of the stored information is no longer possible and the UE considers the cell barred.

Such operation is illustrated by the following pseudocode example for the validity timer function, where upon receiving a MIB an UE shall:
1> store the acquired MIB;
1> if the UE is in RRC_IDLE or in RRC_INACTIVE, or if the UE is in RRC_CONNECTED while timer T311 is running:
   2> if the cellBarred in the acquired MIB is set to “barred”:
      3> if bit validation criteria is met for enabling SIB-less operation,
         4> the cell is considered as barred with “power saving mode”, (i.e., no SIB1 transmissions).
         4> UE shall NOT exclude this barred cell from the candidate for cell selection/reselection for up to configured validity timer value.
         4> UE can apply the stored information to access the “SIB-less mode” cell.
      3> else
         4> consider the cell as barred;
         4> perform cell re-selection to other cells on the same frequency as the barred cell;
   2> else:
      3> apply the received systemFrameNumber, pdcch-ConfigSIB1, sub-CarrierSpacingCommon, ssbSubcarrierOffset and dmrs-TypeA-Position.

The (legacy) cell barring bit of the broadcast SI information can be set to “true” to avoid legacy UEs to camp on the cell when the cell is operating in SIB-less mode. According to a possibility the UE can consider the cell as barred when it cannot acquire the relevant SIB1. The UEs supporting SIB-less operation that have valid information stored their memories for the cell can be configured to not consider the cell as barred and would thus be able to perform all the legacy idle/inactive mode operations in the cell using the stored configurations (e.g., monitoring for paging, accessing the network via RACH, evaluating cell reselection). The UEs supporting SIB-less operation but that do not have valid information stored for the cell can consider the cell as barred and may cell (re-)select/handover to an anchor cell.

Alternatively, the necessary information can be provided via Radio Resource Control (RRC) release messages. For example, RRC release message can provide the necessary system information if the cell is the last cell used by the UE. The last used cell is the cell where the UE receives the RRC release message. The last used cell provisioning the information can be operated with normal mode/SIB-mode, in which case the UE stores the information and thus has no need to read SIB after moving to RRC idle/inactive. The last used cell may also already be in the SIB-less mode. When the UE is moved to the IDLE or inactive mode with RRC release message, the network can indicate the necessary information and the SIB-less mode of operation. The UE stores the information whereafter there is no need for it to try to acquire a SIB from the cell because of the awareness that SIBs, SSBs, or SIB1s are not currently broadcasted.

The relevant SIB information can be stored in appropriate memory at the UE. The information necessary for SIB-less operation to be stored for the network enabling the SIB-less mode operation can be defined in relevant standard specifications. The stored information can comprise information such as paging configurations, RACH configurations, cell reselection configurations, small data transmission (SDT) configurations, unified access control (UAC) configurations and so forth. Alternatively, or additionally, the configurations can be indicated when sending “RRC release” message before the UE switching to RRC-inactive/idle mode, where the current serving cell can be operated with either under normal SIB mode or already in SIB-less mode.

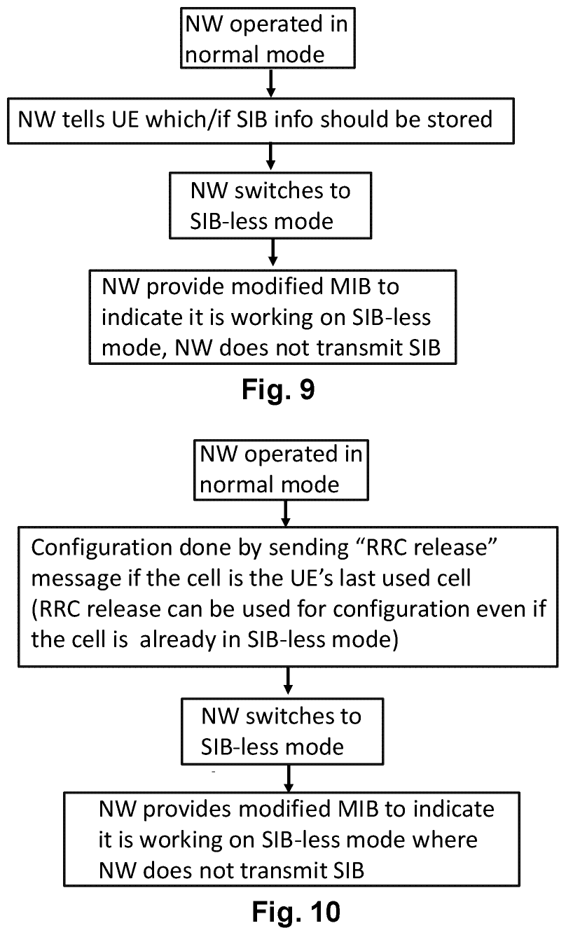

FIG. 9 shows a specific example of switching from normal SIB mode operation to SIB-less mode. An indication of the network operating in SIB-less mode can be provided by the network as a modified MIB to indicate for the UEs if the cell is operating or is going to operate in a SIB-less mode. A spare-bit in the MIB fields or application of bit-value validation jointly with other fields in the MIB can be used for the indication. For example, if the cellBarred field in an acquired MIB is set to barred, the UE can consider the cell to be in SIB-less mode of operation based on the combination where ssb-SubcarrierOffset (4-bit)=0000 and pdcch-ConfigSIB1 (8-bit)=00000000 or 11111111. According to another example the UE can check if a combination is received where ssb-SubcarrierOffset indicates no SIB1 and pdcch-ConfigSIB1=00000000.

After transmitting the indication of a SIB-less mode of operation the network can switch to the SIB-less mode of operation where it does not transit any SIBs.

FIG. 10 shows another example for the switching. In this example the configuration done when sending RRC release message when the cell is the last cell used by the UE. This can be done even if the cell is already in the SIB-less mode.

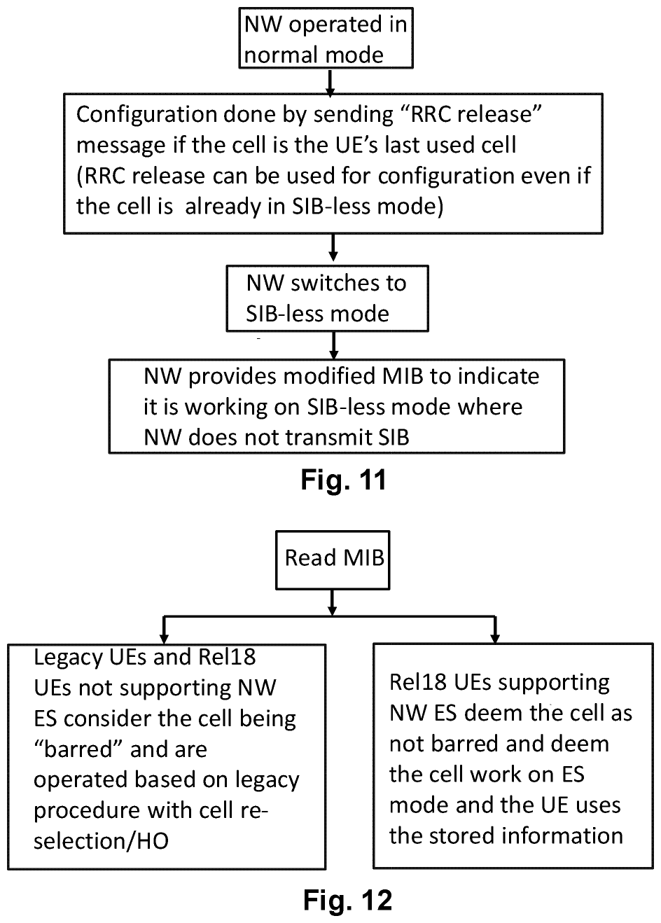

A specific example for behavior of a UE in RRC Inactive/idle state after reception of a modified MIB from the NW is shown in FIG. 11. A UE configured according to 3GPP Release 18 and supporting SIB-less operation can determine that the cell is not barred and operates in SIB-less mode. The UE uses stored SI info for further operations.

FIG. 12 shows scenario where UEs not supporting the SIB-less mode can determine the cell operating in SIB-less mode as being “barred”. The ssb-SubcarrierOffset field of a Synchronization Signal Block (SSB) is used to indicate that there is no SIB1, and the legacy UE can then consider the cell as barred and is not able to camp on the cell. In response to such determination the legacy UE can use legacy procedures such as cell re-selection/handover (HO).

In the case of a Release 18 UE supporting SIB-less, but without stored SI information, the UE can perform a cell re-selection or a handover (HO) to the (anchor) coverage cell. Alternatively, the UE may request or indicate the need for the information from an anchor cell. The request can comprise an on-demand SIB1 request for a given cell ID from another cell. In one example, such on-demand SIB1 request from another cell can be performed before cell reselection to the cell operating in SIB-less mode.

SIB-less mode operation can be applied to multi-carrier applications for reducing/adapting common channels/signals for at least some component carriers (CC). SSB-less secondary cell operation may be provided for some CCs in case of inter-band carrier aggregation (CA). SIB-less operation can be enabled for some CC in case of intra-band and inter-band CA.

The above described principles can advantageously achieve power saving gains by relaxing/muting SIB transmissions, e.g., in low load/empty system.

It is noted that while the above describes example embodiments, there are several variations and modifications which may be made to the disclosed solution without departing from the scope of the present invention. Different features from different embodiments may be combined and order of steps altered.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more general purpose computers, special purpose computers, microprocessors, digital signal processors (DSPs), application specific integrated circuits (ASIC), gate level circuits and processors based on multi core processor architecture, as non-limiting examples.

Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1-23. (canceled)

24. An apparatus, comprising:
at least one processor; and
at least one memory including computer program code; wherein the at least one memory and the computer program code are configured to, with the at least one processor, cause the apparatus at least to:
store system information in the at least one memory for use in access to a cell when network provided system information is unavailable in the cell,
determine that network provided system information is unavailable in the cell,
start a validity timer for the system information stored in the at least one memory,
perform operations for access to the cell based on the stored system information until expiry of the validity timer, and
after expiry of the validity timer at least one of request for system information for the cell from the network or initiate reselection to another cell.

25. The apparatus according to claim 24, wherein the apparatus is enabled, after reselection to another cell, to perform reselection back to the cell before expiry of the timer.

26. The apparatus according to claim 25, wherein the apparatus is caused to check from the network if relevant system information has changed after the reselection back to the cell.

27. The apparatus according to claim 25, wherein the apparatus is caused to use, until expiry of the validity timer and in response to receiving an indication that system information is not transmitted in the cell, the stored system information instead of considering the cell as barred.

28. The apparatus according to claim 25, wherein the apparatus is caused to perform an on-demand system information block (SIB) procedure after the reselection back to camp in the cell when no system information can be acquired by the device in the cell.

29. The apparatus according to claim 24, wherein the apparatus is caused to receive from the network configuration information for the validity timer.

30. The apparatus according to claim 24, wherein the system information comprises information of at least one of: paging configurations, random access channel configurations, cell reselection configurations, small data transmission configurations, or unified access control configurations.

31. The apparatus according to claim 24, wherein the system information and/or timer configuration information is comprised in at least one of: a system information block (SIB), master information block (MIB), synchronization signal block (SSB), or a radio resource control (RRC) message.

32. The apparatus according to claim 24, wherein the system information is comprised in a system information block 1 (SIB1).

33. The apparatus according to claim 24, wherein the apparatus is caused to, in response to expiry of the timer, acquire relevant system information block (SIB) or synchronization information block (SSB) from the network, and in response to not detecting the requested SIB or SSB consider the cell as barred and reselect another cell.

34. A method, comprising:
storing system information in at least one memory for use in access to a cell when network provided system information is unavailable in the cell,
determining that network provided system information is unavailable in the cell,
starting a validity timer for the system information stored in the at least one memory,
performing operations for access to the cell based on the stored system information until expiry of the validity timer, and
after expiry of the validity timer at least one of requesting for system information for the cell from the network or initiating reselection to another cell.

35. The method according to claim 34, further comprising:
performing, after reselection to another cell, reselection back to the cell before expiry of the timer.

36. The method according to claim 34, further comprising:
receiving configuration information for the validity timer.

37. The method according to claim 34, wherein the system information comprises information of at least one of: paging configurations, random access channel configurations, cell reselection configurations, small data transmission configurations, or unified access control configurations.

38. The method according to claim 34, further comprising:
receiving the system information and/or timer configuration information in at least one of: a system information block (SIB), master information block (MIB), synchronization signal block (SSB), or a radio resource control (RRC) message.

39. The method according to claim 34, further comprising:
receiving the system information in a system information block 1 (SIB1).

40. An apparatus comprising:
at least one processor, and
at least one memory including a computer program code, wherein the at least one memory and computer program code are configured to, with the at least one processor, cause the apparatus at least to:
send system information to a communication device in a cell for storage in a memory of the communication device for use in access to the cell when network provided system information is unavailable in the cell,
indicate to the communication device that the cell is operated in a mode of operation where system information is not available in the cell,
indicate a validity timer for the system information stored in the memory, and
allow access by the communication device to the cell based on the stored system information until expiry of the validity timer.

41. The apparatus according to claim 40, wherein the system information comprises information of at least one of: paging configurations, random access channel configurations, cell reselection configurations, small data transmission configurations, or unified access control configurations.

42. The apparatus according to claim 40, wherein the system information and/or timer configuration information is comprised in at least one of: a system information block (SIB), master information block (MIB), synchronization signal block (SSB), or a radio resource control (RRC) message.

43. The apparatus according to claim 40, wherein the system information is comprised in a system information block 1 (SIB1).
